(19) United States
(12) Patent Application Publication
(10) Pub. No.: US 2006/0055090 A1
(43) Pub. Date: Mar. 16, 2006

(54) Method for manufacturing of polymer micro needle array with liga process

(76) Inventors: Seung-seob Lee, Doryong-dong, Yousung-gu (RU); Sang-Joon Moon, Pohang-si (RU)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/542,613

(22) PCT Filed: Jan. 16, 2004
(86) PCT No.: PCT/KR04/00074

§ 371 Date: Jul. 18, 2005

(30) Foreign Application Priority Data
Jan. 16, 2003 (KR) 10-2003-0003041

(51) Int. Cl. B29C 35/08

(52) U.S. Cl. 264/494

(57) ABSTRACT

The present invention relates to a method for manufacturing a micro needle array with an X-ray process. The present invention provides a method for manufacturing a micro needle array, comprising the steps of preparing an X-ray mask by forming an absorber having a configuration of the micro needle array on a substrate; preparing a PMMA cast for the micro needle array by exposing PMMA to vertical and inclined X-rays using the X-ray mask; preparing a flexible PDMS mold having a configuration opposite to that of the PMMA cast by pouring PDMS on the PMMA cast; filling an upper surface of the PDMS mold with a gel type of polymer to obtain a desired thickness of the polymer; patterning a desired configuration of a hole by irradiating UV rays on the polymer; and separating the PDMS mold to complete the polymer micro needle array. The micro needle array of the present invention is made of a polymer material and can be used for drawing blood from or injecting a medicine into the skin.

### TECHNICAL FIELD

The present invention relates to the manufacturing of a micro needle array with a LIGA process, and more particularly, to a method for manufacturing a micro needle array made of a polymer harmless to the human body, wherein manufacturing efficiency is improved by using inclined exposure to X-rays.

### BACKGROUND ART

There have been used needles with a radius of several millimeters or sharp knives in order to extract blood from the skin of a patient or to inject medicine thereinto. However, such a technique leaves excessive scarring and inflicts pain to the subject to be examined. In particular, in diseases such as diabetes, for example, it is necessary to frequently examine the amount of glucose included in blood. When an apparatus such as an apparatus for examining the amount of glucose is used, a patient must inflict wounds in order to frequently measure his/her blood and thus detests the measurement due to the pain of the blood collection process. Further, when a medicine is injected into the human body at a predetermined time interval, a conventional needle may cause the patient to be in danger since it is exposed to external environments such as impact.

To complement such drawbacks, methods for manufacturing micro needles capable of alleviating stimuli at pain spots by manufacturing the micro needles with heights of several hundred micrometers in arrays are disclosed in the following research treatises:
1. Boris Stoeber, and Dorian Liepmann, “Fluid Injection Through Out-Of-Plane Microneedles”, 1^{st} Annual International IEEE-EMBS Special Topic Conference, Lyon, France, Oct. 12-14, 2000, pp. 224-228;
2. J. G. E. Gardeniers, J. W. Berenschot, M. J. de Boer, Y Yeshurun, M. Hefetz, R. van 't Oever, and A. van den Berg, “Silicon Micromachined Hollow Microneedles for Transdermal Liquid Transfer”, MEMS, Vol. 2 (2002), pp. 141-144; and
3. Patrick Griss, and Goron Stemme, “Novel, Side Opened Out-of-Plane Microneedles for Microfluidic Transdermal Interfacing”, Transducer, Vol. 2 (2002), FIGS. 3a to 3f, pp. 467-470.

Processes for manufacturing micro needles disclosed in the treaties are performed through semiconductor processes using silicon or glass.

However, toxic chemicals used for the semiconductor processes are included in micro needles and thus injure the human body. Further, if the sharp needle is fractured due to impact or the like, there may be a severe problem in that fractured pieces of the needle are included in the blood flow and hinder the blood flow. Moreover, if silicon or glass is used, there are problems in that manufacturing processes are complicated and production costs are very high.

### DISCLOSURE OF INVENTION

Accordingly, the present invention is conceived to solve the aforementioned problems in the prior art. An object of the present invention is to provide a polymer micro needle array manufactured with a LIGA process, i.e. by preparing a poly methyl metacrylate (PMMA) cast and a poly dimethyl siloxane (PDMS) mold and manufacturing the needle array using the PDMS mold, thereby improving the manufacturing efficiency and eliminating harmfulness to the human body.

According to the present invention for achieving the object, there is provided a method for manufacturing a micro needle array, comprising the steps of preparing an X-ray mask by forming an absorber having a configuration of the micro needle array on a substrate; preparing a PMMA cast for the micro needle array by exposing PMMA to vertical and inclined X-rays using the X-ray mask; preparing a flexible PDMS mold having a configuration opposite to that of the PMMA cast by pouring PDMS on the PMMA cast; filling an upper surface of the PDMS mold with a gel type of polymer to obtain a desired thickness of the polymer; patterning a desired configuration of a hole by irradiating UV rays on the polymer; and separating the PDMS mold to complete the polymer micro needle array.

In a preferred embodiment of the present invention, the step of preparing the X-ray mask having the configuration of the micro needle array comprises the steps of forming an insulating layer by forming an oxide layer (SiO₂) on the substrate; forming a base substrate for electroforming by depositing a Cr/Au metal layer on the insulating layer; patterning the configuration of the micro needle array using a photosensitive polymer, a developer and an etchant; and forming the X-ray absorber by electroforming an Au layer using the patterned photosensitive polymer and removing the patterned photosensitive polymer.

### BRIEF DESCRIPTION OF DRAWINGS

FIG. 1 is a sectional view showing a micro needle array according to the present invention.

FIGS. 2a to 2g are views illustrating the process of preparing an X-ray mask according to the present invention.

FIGS. 3a to 3d are views illustrating the process of preparing a PMMA cast according to the present invention.

FIGS. 4a to 4d are views illustrating the process of manufacturing the polymer micro needle array according to the present invention.

### BEST MODE FOR CARRYING OUT THE INVENTION

Hereinafter, an embodiment of the present invention will be described in detail with reference to accompanying drawings.

The term “LIGA” is an abbreviation of German words “Lithographie, Galvanoformung and Abformung,” which correspond to English words “lithography, electroforming and molding.” That is, a LIGA process means a micro-processing technique for manufacturing a micro structure through lithography using X-rays, electroforming and molding processes.

The LIGA process has the following features. The heights of structures that can be manufactured through a single process are within the range of several dozen micrometers to several centimeters. Vertical configurations of the manufactured structures can be implemented and the roughness of vertical wall surfaces is about several hundred angstroms. The tolerance of the structures can be implemented as 1/10,000 cm or less. There are a large variety of materials that can be selected through electroforming and (polymer or ceramic) molding processes. Since molding can be performed, a very precise structure can also be mass-produced. Thus, production unit costs are reduced.

Particularly, an X-ray exposure step and a development step are important in performing such a LIGA process. To minimize errors in dimension during the X-ray exposure and development steps, an X-ray mask for controlling selective transmissivity of an X-ray light source is important. That is, the X-ray mask is a mechanism that is disposed between a photoresist and the X-ray light source during the X-ray lithography process to selectively transmit X-rays.

In the LIGA process, the X-ray mask should easily transmit X-rays without loss at portions on which the X-rays are required to be irradiated while thoroughly shielding X-rays below a predetermined level of energy at portions on which the X-rays are not required to be irradiated.

In an X-ray mask currently used in the LIGA process, a thin membrane made of silicon nitride is formed on a substrate and an X-ray absorber made of gold (Au) is formed on the membrane. The silicone nitride membrane transmits X-rays substantially without loss, and X-rays cannot be transmitted at a portion where the X-ray absorber is formed. Therefore, a membrane at a portion where an X-ray absorber does not exist easily transmits X-rays so that PMMA 6 or the photoresist can be exposed to the X-rays.

Meanwhile, in a workpiece with the exposed PMMA or photoresist, an exposed portion is completely removed through the development process so that an electroforming base layer or metallic surface can be revealed. Then, electroforming is performed.

After electroforming is performed on the developed portion with a pattern using a metal such as Ni or NiP, the PMMA or photoresist is removed. Accordingly, it is possible to control the surface roughness of the structure manufactured through the single process up to about several hundred angstroms.

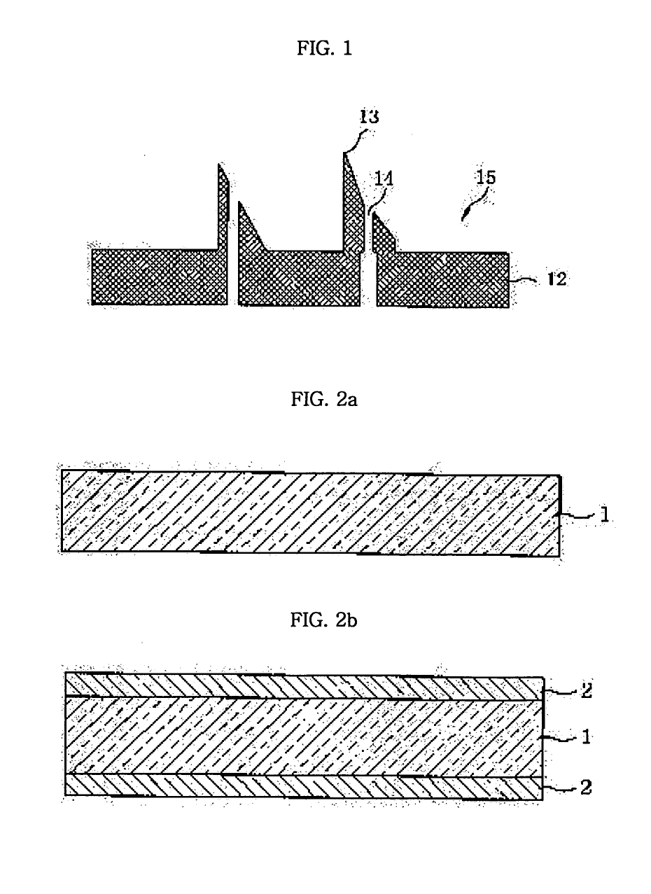

FIG. 1 is a (side) sectional view of a micro needle array according to the present invention. As shown in FIG. 1, the micro needle array 15 of the present invention comprises a sharp tip 13 capable of penetrating the skin, and a channel 14 through which blood can be collected. Preferably, the sharp tip 13 is formed to be sharpened enough to minimize damage to skin structure and pain.

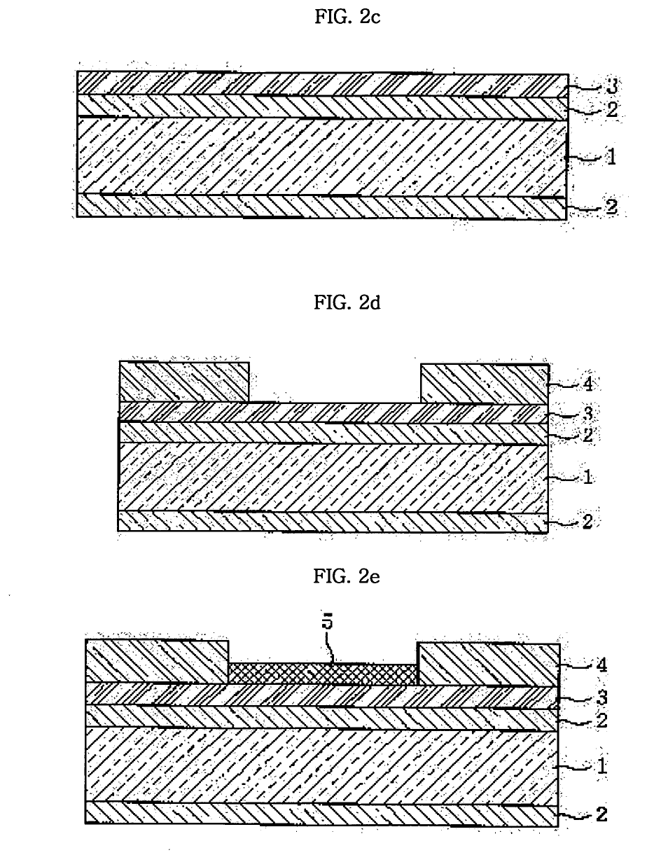

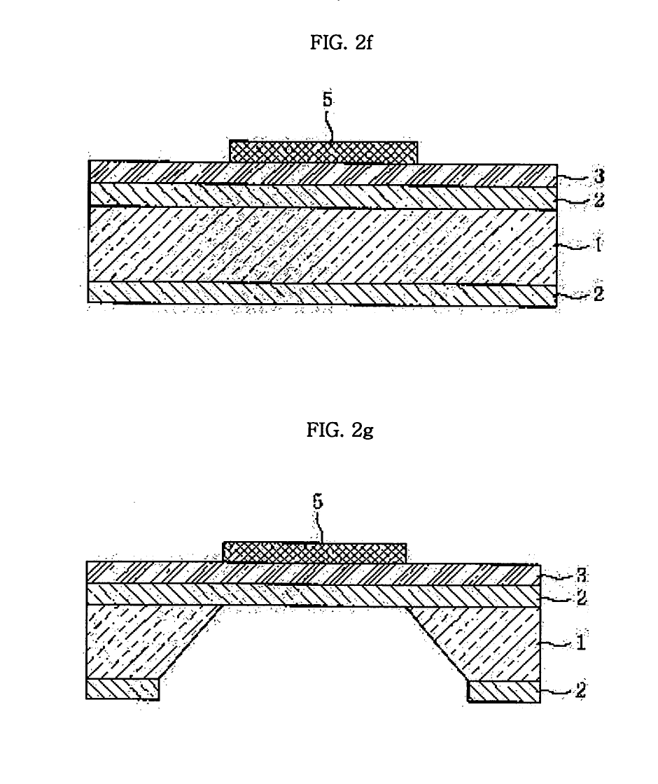

FIGS. 2a to 4d are views illustrating the process of manufacturing the micro needle array with the LIGA process in accordance with the present invention.

FIGS. 2a to 2g are views illustrating the process of manufacturing the X-ray mask by forming an absorber with the structure of the micro needle array on a silicon substrate. Referring first to FIG. 2a, a silicon substrate 1 (100 μm in thickness, <100> orientation, N type) or a boron nitride substrate is cleaned using a diluted solution of sulfuric acid (H₂SO₄) and hydrogen peroxide (H₂O₂) at a ratio of 1:2 for 40 minutes at 120° C. to remove metal or organic residues that are contaminants.

Referring now to FIG. 2b, the silicon substrate 1 is put within an oxidation furnace and then oxidized with deionized (DI) water for 6 hours at 100° C. to form an oxide layer (silicon oxide; SiO₂) with a thickness of about 1.2 μm. In order to improve insulating properties and form a thin film, a low stress nitride layer with a thickness of 4,000 angstroms may be additionally formed through a low pressure chemical vapor deposition (LPCVD) process after the oxide layer is formed. As for the low stress nitride layer for forming the thin film, the thin film is formed by bulk etching the silicon substrate 1.

Referring to FIG. 2c, in order to form a substrate electrode used for electroforming on the insulation layer 2, a Cr/Au metal layer 3 is deposited thereon using a thermal evaporator. Cr is deposited in a total thickness of 200 angstroms at a deposition rate of 1 Å/sec for about 2 minutes with an electric current of 55 to 60 A in order to improve adhesiveness of Au to the substrate 1. Then, Au is deposited with a total thickness of 2,000 angstroms at a deposition rate of 1 to 1.5 Å/sec for about 10 to 15 minutes with an electric current of 50 to 55 A.

Referring to FIG. 2d, an AZ 9260 photosensitive polymer (photoresist) 4 is applied in a thickness of about 23 μm by a rotary dispenser (for 40 seconds at 200 rpm and 5 seconds at 1,000 rpm) and then soft-baked for 120 seconds at 110° C. To pattern a mask having a configuration of a micro needle array, the polymer is exposed to ultraviolet rays having an intensity of 8 mW/cm² for 4 minutes using a UV mask. Then, it is subjected to a development process for 15 minutes using an AZ 400K developer, cleaned with DI water and dried using N₂ gas.

Referring to FIG. 2e, an Au layer 5 is electroformed with a current density of 1.5 mA for about 6 hours using the patterned polymer 4. Referring now to FIG. 2f, the patterned photosensitive polymer 4 is removed using acetone and methanol. Here, since the oxide layer 2 and the silicon substrate 1 correspond to regions through which X-rays penetrate, and the electroformed Au layer 5 becomes an absorber that absorbs the X-rays, there is provided an X-ray mask capable of allowing the X-rays to selectively penetrate therethrough.

Meanwhile, in case of the silicon substrate 1 covered with the low stress nitride layer, as shown in FIG. 2g, the silicon substrate 1 is etched with a KOH solution to form a nitride thin film.

In such a way, the X-ray mask for use in the LIGA process is prepared through the processes illustrated in FIGS. 2a to 2g.

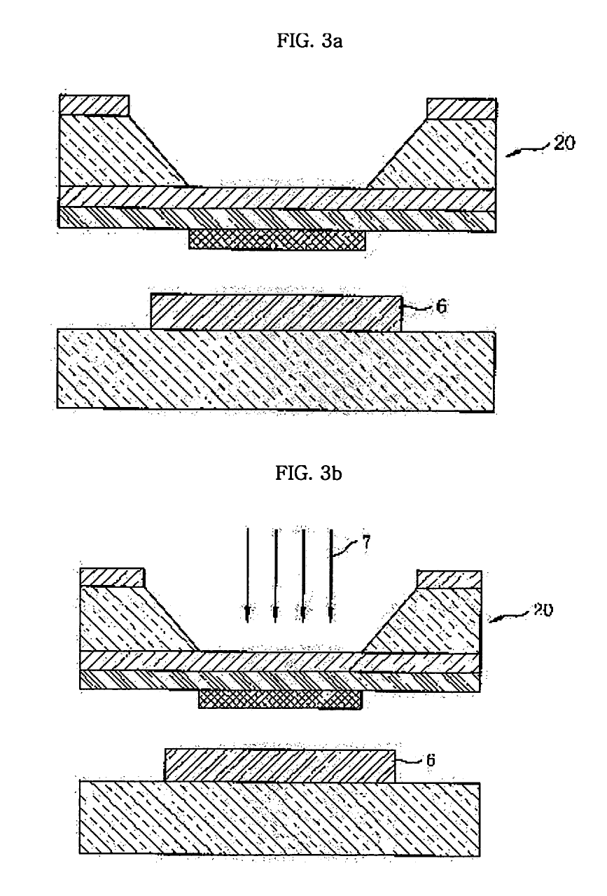

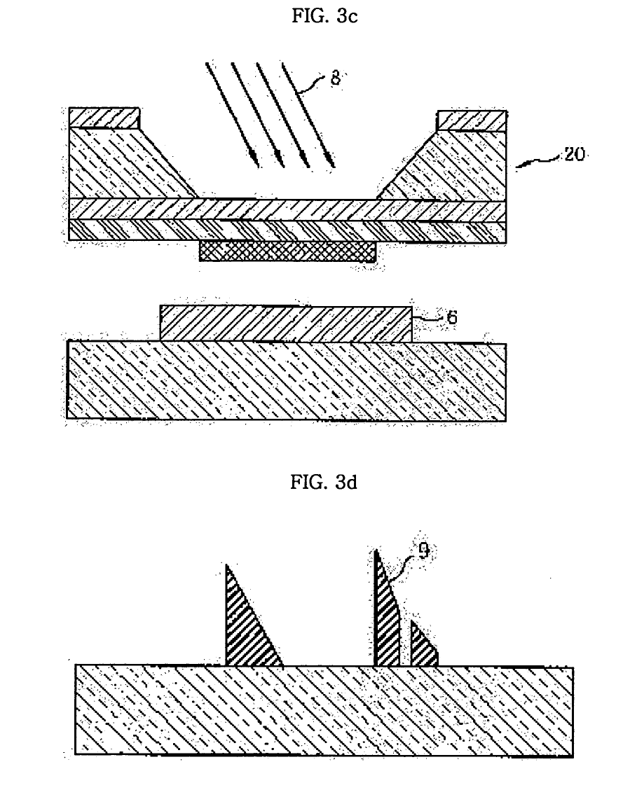

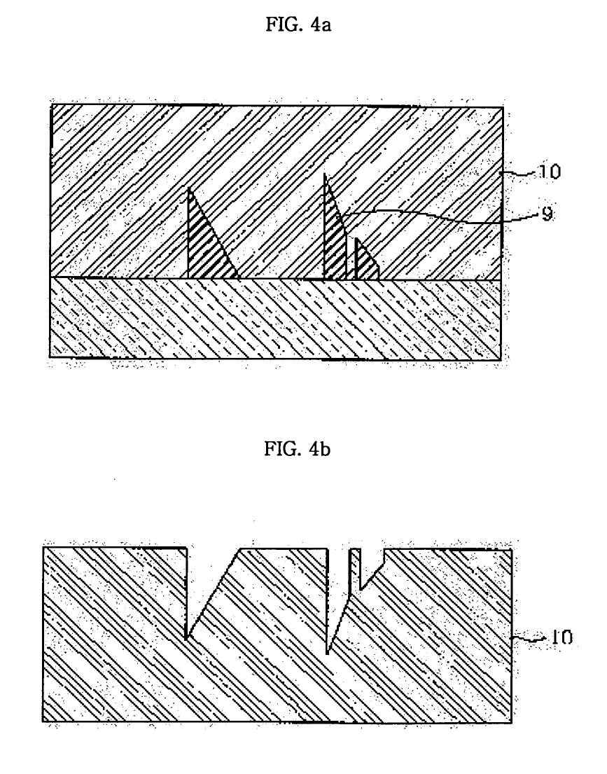

FIGS. 3a to 3d are views illustrating the manufacturing processes of preparing a PMMA cast of a micro needle array by causing PMMA to be subjected to vertical and inclined exposure to X-rays using the X-ray mask covered with the low stress nitride layer. Referring to FIGS. 3a through 3d, the X-ray mask 20 is registered on the PMMA 6 that is in turn exposed to vertical X-rays 7 and inclined X-rays 8. Then, portions of the PMMA 6 which have been exposed to the X-rays are developed and removed. The other portions of the PMMA 6 remaining after the development become the PMMA cast 9. The PMMA cast 9 prepared as such is a cast for a poly dimethy siloxane (PDMS) mold 10 that will be prepared through subsequent processes, and thus, has a configuration opposite to that of the PDMS mold.

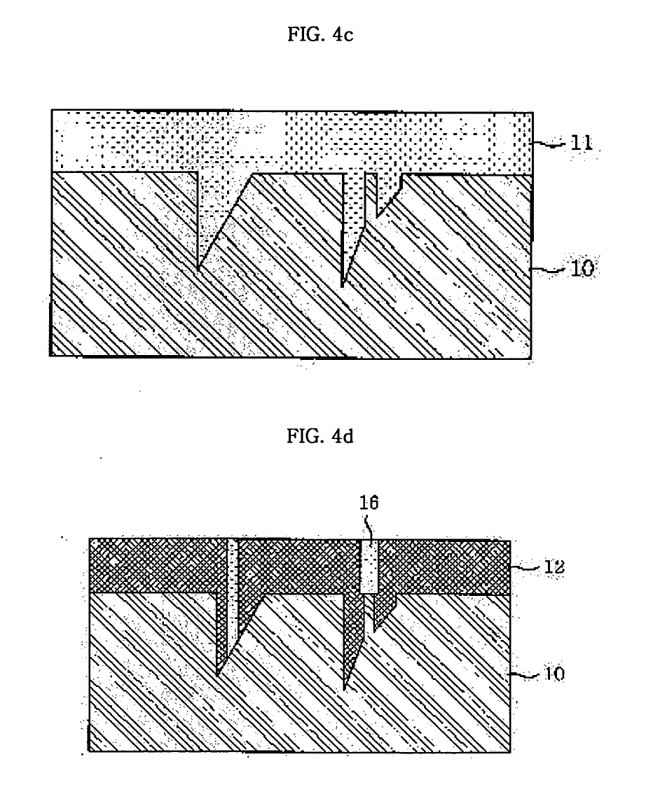

FIGS. 4a to 4d are views illustrating the processes of manufacturing a polymer micro needle array using the PMMA cast. Referring to FIG. 4a, in order to obtain the micro needle array 15, surfaces of the PMMA cast 9 and the substrate 1 are silanized so that the PDMS mold 10 can be easily separated therefrom after it is cured. As for chemicals for the silanization, chemicals obtained through silanization by putting about 10 μl of trichloro(3,3,3 trifluoro propyl)silane within a vacuum vessel for 8 hours are used. PDMS prepared by mixing a monomer with a curing agent at a ratio of 10:1 and removing bubbles is poured on the previously prepared PMMS cast 9 to manufacture the PDMS mold 10. Bubbles created during the pouring process are removed from the PDMS that in turn is heat treated for about 1 hour at 100° C. and then cured. When the cured PDMS mold 10 is separated from the PMMS cast, the completed flexible mold 10 is obtained to be used for manufacturing a polymer micro needle array. At this time, since the PDMS mold 10 is separated cleanly, it is possible to easily obtain a lot of flexible molds by directly repeating the processes of pouring PDMS comprising a curing agent and performing heat treatment without an additional process.

Referring to FIG. 4b, the cured PDMS mold 10 is separated from the PMMA cast 9.

Referring to FIG. 4c, a polymer 11, SU-8 (70 wt % EPON, 30 wt % GBL), is applied to the PDMS mold 10 by a rotary dispenser (for 5 minutes at 200 rpm and 35 minutes at 1,000 rpm) or through direct injection to form a container with a thickness of about 500 μm and then pre-baked at 95° C. Since SU-8 is a negative photoresist, it is exposed to light around 365 nm with an intensity of 3,000 to 4,000 mJ/cm² using a UV mask. Then, the polymer is post-baked at 95° C., and subsequently developed and cleaned with propyleneglycol monomethylether acetate (PGMEA) for 15 minutes. After cleaning, it is hard baked at 200° C. If a method such as UV embossing or injection molding is used, a polymer suitable for the molding method is used.

Referring to FIG. 4d, a polymer 12 is applied to the PDMS mold 10 and then baked. UV rays are irradiated on the polymer to be exposed thereto according to a desired configuration of a hole 16. Thereafter, the hole 16 of the micro needle array is patterned with a developer and an etchant. Then, the polymer (SU-8) 12 is completely cured to improve mechanical properties thereof. The micro needle array made of the cured polymer 12 manufactured as such is separated from the flexible PDMS mold 10.

Therefore, the polymer micro needle array 15 shown in FIG. 1 can be manufactured through the manufacturing processes described above.

### INDUSTRIAL APPLICABILITY

As described above, the polymer micro needle array of the present invention is manufactured using a mold that has been prepared using the LIGA process. The micro needle array can be used with an apparatus for drawing blood from the skin or delivering a medicine through the skin.

Further, the micro needle array of the present invention is made of a polymer harmless to the human body, and can be easily used for injecting a medicine or drawing blood while penetrating into the skin without pain. The method of manufacturing the micro needle array using a mold allows reduction in production costs and facilitates mass production of the micro needle array.

1. A method for manufacturing a micro needle array, comprising the steps of:
preparing an X-ray mask by forming an absorber having a configuration of the micro needle array on a substrate;
preparing a PMMA cast for the micro needle array by exposing PMMA to vertical and inclined X-rays using the X-ray mask;
preparing a flexible PDMS mold having a configuration opposite to that of the PMMA cast by pouring PDMS on the PMMA cast;
filling an upper surface of the PDMS mold with a gel type of polymer to obtain a desired thickness of the polymer;
patterning a desired configuration of a hole by irradiating UV rays on the polymer; and
separating the PDMS mold to complete the polymer micro needle array.

2. The method according to claim 1, wherein the step of preparing the X-ray mask having the configuration of the micro needle array comprises the steps of:
forming an insulating layer by forming an oxide layer (SiO₂) on the substrate;
forming a base substrate for electroforming by depositing a Cr/Au metal layer on the insulating layer;
patterning the configuration of the micro needle array using a photosensitive polymer, a developer and an etchant; and
forming the X-ray absorber by electroforming an Au layer using the patterned photosensitive polymer and removing the patterned photosensitive polymer.

3. The method according to claim 2, wherein the substrate comprises a silicon substrate, a boron nitride (BN) substrate, or a substrate with a low stress nitride layer.
